(19) United States
(12) Patent Application Publication
(10) Pub. No.: US 2026/0362176 A1
(43) Pub. Date: Nov. 12, 2026

(54) COOPERATIVE SENSING

(71) Applicant: LENOVO (BEIJING) LIMITED, Beijing (CN)

(72) Inventors: Haiyan LUO, Shanghai (CN); Zhong YE, Hangzhou (CN); Guanding YU, Hangzhou (CN); Jianfeng WANG, Beijing (CN)

(21) Appl. No.: 19/130,700

(22) PCT Filed: Nov. 18, 2022
(86) PCT No.: PCT/CN2022/132955

§ 371 Date: May 16, 2025

(51) Int. Cl. H04W 24/08; H04W 64/00

(52) U.S. Cl. CPC H04W 24/08; H04W 64/00

(57) ABSTRACT

Method and apparatus for cooperative sensing are disclosed. In one embodiment, a SF comprises a processor and a transceiver coupled to the processor, wherein the processor is configured to receive, from a first network node, via the transceiver, a first sensing service request, wherein, the first sensing service request includes an ID of a UE and an ID of a RAN node, the RAN node is a serving RAN node of the UE; and transmit, to the RAN node, via the transceiver, a second sensing service request, wherein, the second sensing service request includes the ID of the UE.

### FIELD

The subject matter disclosed herein generally relates to wireless communications, and more particularly relates to cooperative sensing.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Artificial Intelligence (AI), Integrated sensing and communication (ISAC), signal-to-noise ratio (SNR), Application Function (AF), Network Exposure Function (NEF), Unified Data Management (UDM), Access and Mobility Management Function (AMF), Radio Access Network (RAN), Network Repository Function (NRF), Sensing Function (SF), SF-Control Plane (SF-C), SF-User Plane (SF-U), Operation, Administration and Management (OAM), Convolutional Neural Network (CNN), Unmanned Aerial Vehicle (UAV), Vehicle to Everything (V2X).

The development of next-generation wireless communication systems is not limited to seeking high data rate and low communication latency, but also tends to be intelligentialized with the help of Artificial Intelligence (AI) technique. Toward this end, there are three necessities: sensing data for supporting AI algorithms, communication for information delivery, and computation ability for implementing AI algorithms. Therefore, 6G systems are expected to be the unity of mobile communication networks, sensing networks, and compute first networking. Integrated sensing and communication (ISAC) is proposed as one of the critical techniques in 6G systems. ISAC aims to achieve sensing function and communication function with shared hardware simultaneously.

The sensing function can be performed by a sensing node, e.g., a base station (e.g., gNB) or a UE. The sensing target can be a sensing object, e.g., a UE, or a sensing area. In some cases, when a single sensing node performs the sensing function, the single sensing node may not be able to achieve some sensing tasks, such as obstacle detection in multiple directions in a sensing area to achieve obstacle avoidance. In addition, the sensing accuracy for a sensing object may not be enough if the sensing object is sensed by a single sensing node.

This invention targets cooperative sensing.

### BRIEF SUMMARY

Method and apparatus for cooperative sensing are disclosed.

In one embodiment, a SF comprises a processor and a transceiver coupled to the processor, wherein the processor is configured to receive, from a first network node, via the transceiver, a first sensing service request, wherein, the first sensing service request includes an ID of a UE and an ID of a RAN node, the RAN node is a serving RAN node of the UE; and transmit, to the RAN node, via the transceiver, a second sensing service request, wherein, the second sensing service request includes the ID of the UE.

In some embodiment, the second sensing service request further includes cooperative sensing information. The cooperative sensing information may be a cooperative sensing indication or a list of neighbor RAN nodes of the RAN node.

In some embodiment, the processor is further configured to receive, from the RAN node, via the transceiver, a primary sensing result including the location of the UE; determine whether to perform a cooperative sensing involving neighbor network nodes of the RAN node; transmit, to each of the determined neighbor network nodes, via the transceiver, a third sensing service request including the location information of the UE; and receive, from each of the determined neighbor network nodes, via the transceiver, a sensing result. In some embodiment, whether to perform the cooperative sensing is determined according to a service type included in the first sensing service request; or whether a predefined accuracy being met by the accuracy of the location information of the UE based on the primary sensing result. In some embodiment, the neighbor network nodes of the RAN node are determined according to location information of the UE based on the primary sensing result, and information about neighbor RAN nodes. The information about the neighbor RAN nodes may be pre-configured, obtained from the first network node, or obtained from a second network node.

In another embodiment, a RAN node comprises a processor and a transceiver coupled to the processor, wherein the processor is configured to receive, from a sensing function (SF), via the transceiver, a first sensing service request including an ID of a UE which indicates an sensing object; perform sensing towards the sensing object identified by the ID of the UE to obtain location information of the sensing object; and transmit, to neighbor RAN nodes of the RAN node, via the transceiver, a second sensing service request for the sensing object including the location information of the sensing object.

In some embodiment, the processor is further configured to determine to transmit the second sensing service request according to a service type included in the first sensing service request; or whether a predefined accuracy being met by the accuracy of the obtained location information of the sensing object.

In some embodiment, the neighbor RAN nodes are determined according to an indication of cooperative sensing included in the first sensing service request.

In some embodiment, the neighbor RAN nodes are determined according to a list included in the first sensing service request.

In some embodiment, the neighbor RAN nodes are determined according to the obtained location information of the sensing object, and information about neighbor RAN nodes.

In yet another embodiment, a UE comprises a transceiver; and a processor coupled to the transceiver, wherein the processor is configured to receive, from a network node, via the transceiver, a first sensing service request including a task ID, and at least one of an indication of cooperative sensing and sensing time info; and transmit, to each of selected neighbor UEs, via the transceiver over sidelink, a second sensing service request.

In some embodiment, the processor is further configured to transmit, to a serving RAN node of the UE, via the transceiver, a first sensing resource request, wherein, the first sensing resource request includes the number of sensing resources, and at least one of an indication of cooperative sensing and sensing time info.

In some embodiment, the processor is further configured to transmit, to a serving RAN node of the UE, via the transceiver, a second sensing resource request, wherein, the second sensing resource request includes the task ID, and at least one of an indication of cooperative sensing and sensing time info.

In some embodiment, the processor is further configured to select sensing resource from a resource pool of pre-configured sensing resources based on sensing time info.

In some embodiment, the second sensing service request includes at least one of sensing time info and an indication of reporting to RAN node.

In further embodiment, a method performed at a SF comprises receiving, from a first network node (e.g., AMF or AF), a first sensing service request, wherein, the first sensing service request includes an ID of a UE (which indicates a sensing object) and an ID of a RAN node, the RAN node is a serving RAN node of the UE; and transmitting, to the RAN node, a second sensing service request, wherein, the second sensing service request includes the ID of the UE.

In another further embodiment, a method performed at a RAN node comprises receiving, from a sensing function (SF), a first sensing service request including an ID of a UE which indicates an sensing object; performing sensing towards the sensing object identified by the ID of the UE to obtain location information of the sensing object; and transmitting, to neighbor RAN nodes of the RAN node, a second sensing service request for the sensing object including the location information of the sensing object.

In yet another further embodiment, a method performed at a UE comprises receiving, from a network node, a first sensing service request including a task ID, and at least one of an indication of cooperative sensing and sensing time info; and transmitting, to each of selected neighbor UEs, over sidelink, a second sensing service request.

### BRIEF DESCRIPTION OF THE DRAWINGS

A more particular description of the embodiments briefly described above will be rendered by referring to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of gNB based sensing;

FIG. 2 illustrates a first sub-embodiment of the first embodiment;

FIG. 3 illustrates a second sub-embodiment of the first embodiment;

FIG. 4 illustrates a first sub-embodiment of a second embodiment;

FIG. 5 illustrates a second sub-embodiment of the second embodiment;

FIG. 6 is a schematic flow chart diagram illustrating an embodiment of a method;

FIG. 7 is a schematic flow chart diagram illustrating an embodiment of a method;

FIG. 8 is a schematic flow chart diagram illustrating an embodiment of a method;

FIG. 9 is a schematic flow chart diagram illustrating an embodiment of a method;

FIG. 10 is a schematic flow chart diagram illustrating an embodiment of a method; and

FIG. 11 is a schematic block diagram illustrating another apparatus according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

As described in the background part, if the sensing function is performed by a single sensing node (e.g., a gNB or a UE), some sensing tasks may not be achieved. In view of the above, this disclosure proposes cooperative sensing, which means that sensing function can be performed by multiple sensing nodes (e.g., multiple RAN nodes (e.g., multiple gNBs) or multiple UEs).

As described above, the sensing function can be performed by a base station (e.g., gNB or RAN node) or by a UE. It means that the sensing can be generally divided into gNB based sensing and UE based sensing. In the following description, the base station is represented by gNB. Incidentally, gNB is denoted as ‘RAN node’ in the Drawings. The cooperative sensing can be applied for both gNB based sensing and UE based sensing, and can be referred to as gNB based cooperative sensing and UE based cooperative sensing, respectively.

A first embodiment relates to gNB based cooperative sensing.

Before describing cooperative sensing, a gNB based sensing procedure is described with reference to FIG. 1.

In gNB based sensing, it is assumed that the sensing target may be a sensing object such as a vehicle or a person. The sensing object (e.g., vehicle or person) can be regarded as a UE, and be represented by a sensing object ID (e.g., UE ID). It is assumed that the location of the sensing object is unknown by the sensing consumer (e.g., AF). It means that the sensing consumer only knows the ID (e.g., UE ID) of the sensing object. The sensing procedure illustrated in FIG. 1 can be applied to various sensing scenarios such as vehicle tracking, positioning, obstacle avoidance, and other vehicular scenarios.

In step 110, AF transmits to NEF a sensing service request #1. The sensing service request #1 includes task ID that is used to identify different tasks, UE ID (e.g., UE ID #1) that is used to identify the sensing target (e.g., sensing object), and sensing parameters. The sensing parameters may include but not limited to: service type (e.g., localization, trajectory prediction, etc), sensing data type (e.g., angle, distance, velocity, etc), sensing requirement (e.g., sensing accuracy). UE ID (e.g., UE ID #1) can be in the form of GPSI or SUPI etc.

In step 120, NEF checks the sensing service request (i.e., the sensing service request #1) from AF for authorization. The authorization information can be stored locally in NEF. Alternatively, the authorization information is stored in UDM while NEF requests the UDM for authorization verification.

In step 130, if the authorization is verified, NEF selects an appropriate AMF and sends a sensing service request #2 to AMF. The sensing service request #2 includes task ID, UE ID (e.g., UE ID #2), and the sensing parameters (which are the same as the sensing parameters included in the sensing service request #1). UE ID #2 is a UE ID that can be recognized by AMF. For example, UE ID #2 is SUPI. NEF may translate UE ID #1 to UE ID #2. If UE ID #1 can be recognized by AMF, e.g., SUPI, the NEF does not perform UE ID translation but just simply set UE ID #2 as UE ID #1. The UE ID (e.g., UE ID #2) can be used by AMF to identify the UE (i.e., the sensing object) so that AMF can find the serving gNB (i.e., serving RAN node) of the UE.

Alternatively to steps 110, 120 and 130, if the sensing service request is sent by a UE (i.e., the sensing service is triggered by the UE), the sensing service request is sent from the UE to AMF via RAN node.

In step 140, AMF uses the UE ID #2 (e.g., SUPI) to locate the serving gNB (i.e., serving RAN node) of the sensing object. AMF converts the UE ID #2 into the UE ID #3 that can be recognized by the RAN node. For example, UE ID #3 can be in the form of AMF UE NGAP ID and/or RAN UE NGAP ID. AMF selects SF according to the location information of the serving RAN node (corresponding to the serving area of SF), and optionally further according to the service type included in the sensing service request #2 and other factors (e.g., supported sensing accuracy by each SF). It is assumed that each SF corresponds to a serving area and each SF has registered its serving area and optionally supported sensing type(s) and supported sensing accuracy with NRF. Accordingly, AMF can obtain the sensing area info, the supported sensing type and the supported accuracy of each SF by referring to NRF.

Incidentally, SF-C stands for SF control plane and SF-U stands for SF user plane. SF refers to both SF-C and SF-U. Alternatively, both SF-C and SF-U can be integrated in one SF.

In step 150, AMF sends a sensing service request #3 to the selected SF (e.g., SF-C). The sensing service request #3 includes task ID, UE ID (e.g., UE ID #3), serving RAN node ID, and the sensing parameters. Serving RAN node ID can be in the form of global RAN node ID, e.g., Global gNB ID, Global ng-eNB ID, etc.

In step 160, SF or the serving RAN node triggers cooperative sensing service procedure, which is related to the cooperative sensing and will be described later.

In step 170, SF uses the sensing data (e.g., angle, distance, velocity) received from the serving RAN node and optionally from the neighbor RAN nodes to perform cooperative sensing computation. For example, if the service type is trajectory prediction, after obtaining the angle, distance and velocity of the sensing object at the current time, the angle, distance and velocity of the sensing object at the next time are deduced by using the geometric function relationship between the previous and subsequent times, so as to achieve the trajectory prediction function.

In step 180, SF returns a sensing service response to the AMF. The sensing service response includes the sensing result. The sensing result may be different for different tasks. For example, for obstacle detection task, the sensing result may be nearby obstacle information and the preferred driving road information. For trajectory prediction task, the predicated sensing result may be calculated based on the sensing object location information obtained at the current moment. For example, if it is assumed that the sensing object is moving at a constant velocity along a line, the angle and distance of the next moment can be calculated based on the current angle and distance at the current moment and the constant velocity. For precise location task, the sensing result may be a more accurate location information obtained by multiple gNBs. In step 190, AMF returns the sensing service response to the AF via NEF. Alternatively, in step 180, SF may return the sensing service response to AF directly (or via NEF to AF). In this condition, step 190 is unnecessary.

Incidentally, if the sensing service is triggered by a UE, AMF returns the sensing service response to the UE via its serving RAN node.

The gNB based cooperative sensing (i.e., step 160) is described in detail. For gNB based cooperative sensing for a specific sensing object, the key issues include: 1) how does each RAN node identify a sensing object (e.g., UE) if the sensing object has not connected to the RAN node; 2) how to trigger cooperative sensing; and 3) how to select the cooperative RAN nodes (i.e., the RAN nodes that perform the cooperative sensing).

The gNB based cooperative sensing can be triggered by SF or by serving gNB (i.e., serving RAN node).

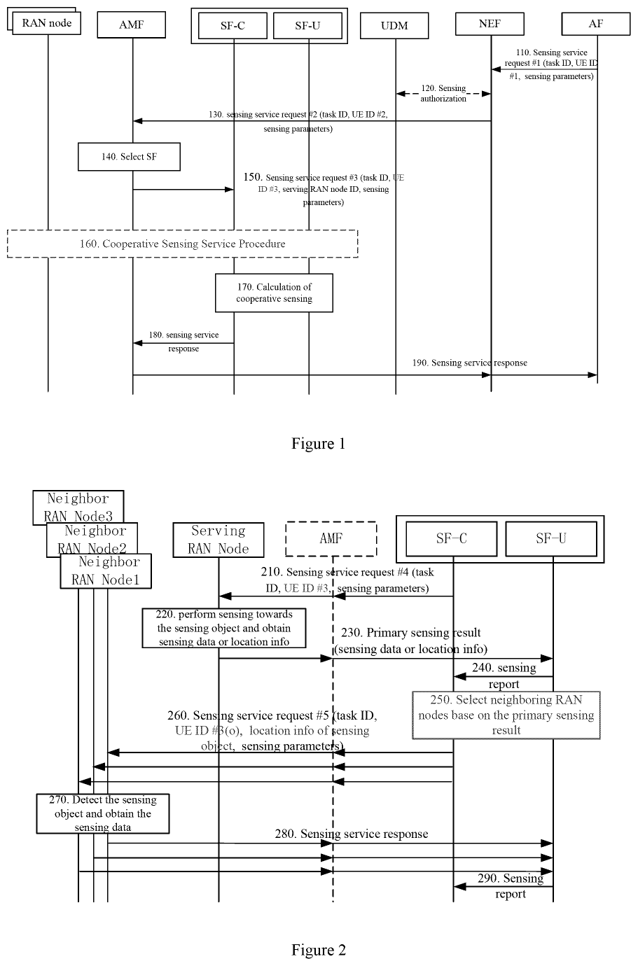

FIG. 2 illustrates a first sub-embodiment of the first embodiment, which relates to SF triggering gNB based cooperative sensing. Steps 210-290 in FIG. 2 are an implementation of step 160.

In the following description, it is assumed that SF-C (sensing function control plane, which interacts with existing 5GC control plane network elements and is responsible for control plane messaging, providing addresses for SF-U (sensing function user plane) to gNB and/or UE) and SF-U (sensing function user plane, which collects and analyzes the sensing measurement data generated by the gNB or the UE to obtain the final sensing results) are two entities. If SF-C and SF-U are collocated as SF, the steps performed at each or both of SF-C and SF-U are performed at SF. For example, steps 240, 250 and 290 become internal implementation in SF.

In step 210, SF-C sends a sensing service request #4 via AMF to the serving RAN node based on the RAN node ID provided by AMF. The sensing service request #4 includes task ID, UE ID (e.g., UE ID #3), and the sensing parameters. Incidentally, for loosely coupled architecture (which is relatively independent from the existing 5GC, and the sensing function does not need to interact with the 5GC or only performs less interaction), SF (e.g., SF-C) can send the sensing service request #4 directly to the RAN node without going through AMF. Optionally, a user plane tunnel can be established between the SF and the serving RAN node. Alternatively, SF provides a notification address (e.g., address of SF-U) along with the sensing service request #4, where notification address may be in the form of IP address and optionally port number.

In step 220, the serving RAN node performs sensing towards the sensing object identified by the UE ID #3, and obtains sensing data (e.g., angle, distance, velocity, etc.) or location information (e.g., X, Y and/or Z coordinate(s), optionally together with radius) of the sensing object. Specifically, assume the serving RAN node is located at the original point, and the sensing object is located with specific angle and specific distance relative to the original point in the coordination system. To be more specific, sensing data is the data obtained by the serving RAN node, while location information is calculated from the sensing data obtained by the serving RAN node.

In step 230, the serving RAN node sends a primary sensing result, which may be sensing data (e.g., angle, distance, velocity) or location information of the sensing object to SF-U via AMF. For the loosely coupled architecture, the serving RAN node can send the primary sensing result directly to the SF without going through AMF.

In step 240, SF-U informs SF-C that it has obtained the primary sensing result from the serving RAN node.

In step 250, if the primary sensing result is sensing data, SF calculates the location information of the sensing object according to the sensing data (e.g., angle, distance, velocity, etc.). For example, SF calculates the X, Y and/or Z coordinates of the sensing object based on the angle, the distance and the X, Y and/or Z coordinates of the original point (e.g., the original point is the location of the serving RAN node). SF determines whether cooperative sensing is necessary. For example, SF determines whether cooperative sensing is necessary according to the service type included in the sensing service request #4. In particular, if the service type is multi-directional obstacle detection, cooperative sensing is enabled by default. For another example, SF determines whether cooperative sensing is necessary according to whether a predefined accuracy being met by the accuracy of the location information of the sensing object. In particular, if sensing requirement requires a predetermined accuracy while the calculated location information of the sensing object indicates an accuracy that does not meet the predetermined accuracy, cooperative sensing is enabled. When the cooperative sensing is determined, SF selects neighbor RAN nodes based on the location of the sensing object and information about the neighbor RAN nodes. The information about the neighbor RAN nodes includes RAN node information (e.g., RAN node ID, sensing capability, supported service type, supported sensing accuracy, location information etc.) of each RAN node, and can be obtained by SF by one of the following manners. Incidentally, the location information of the neighbor RAN node is necessary to be used to calculate the location information of the sensing object if the neighbor RAN node will provide the sensing data (instead of the location information of the sensing object).
1) RAN node information of each RAN node is preconfigured to SF by OAM.
2) Each RAN node provides its RAN node information upon NG interface setup with an AMF, and the AMF provides RAN node information of each RAN node when the AMF is registered to NRF. SF can retrieve (i.e., obtain) RAN node information of each RAN node associated with the AMF from the NRF.
3) AMF provides SF with the information about the neighbor RAN nodes of the serving RAN node when the AMF provides the SF with the sensing service request including the serving RAN node ID, e.g., in step 150.

Based on the previous steps, the key issues 2) how to trigger cooperative sensing and 3) how to select the cooperative RAN nodes are resolved.

In step 260, SF-C sends a sensing service request #5 to each of the selected neighbor RAN nodes via AMF. The sensing service request #5 includes task ID, UE ID (e.g., UE ID #3) (optional), location information of the sensing object provided by the serving RAN node, and sensing parameters. In this case, as the UE does not have a connection with neighbor RAN node, neighbor RAN node is not able to perform sensing based on the UE ID included in sensing service request #5. On the other hand, the neighbor RAN node can identify the sensing object according to the location of the sensing object. It means that the location information of the sensing object solves the key issue 1), i.e., how does each RAN node identify a sensing object (e.g., UE) if the sensing object has not connected to the RAN node. For the loosely coupled architecture, SF can send the sensing service request #5 directly to each of the selected neighbor RAN nodes without going through AMF.

In step 270, each of the selected neighbor RAN nodes detects the sensing object based on the location information of the sensing object and obtains the sensing data (e.g., angle, distance, velocity, etc.) or location information of the sensing object.

In step 280, each of the selected neighbor RAN nodes sends the sensing result, which is sensing data and/or the location information of the sensing object, together with the task ID and the UE ID #3 (optional) to SF-U via AMF. For the loosely coupled architecture, each of the selected neighbor RAN nodes can send the sensing result directly to SF-U without going through AMF. Alternatively, the sensing result can be transmitted from each of the selected neighbor RAN nodes to SF-C (e.g., via or without AMF).

In step 290, SF-U collects the sensing result with same task ID and UE ID #3 (optional) from the neighbor RAN nodes, and informs SF-C that it has obtained the sensing data (angle, distance, velocity) or location information. Then, the procedure continues to step 170 of FIG. 1.

As a whole, in the first sub-embodiment of the first embodiment, the SF triggers the gNB based cooperative sensing.

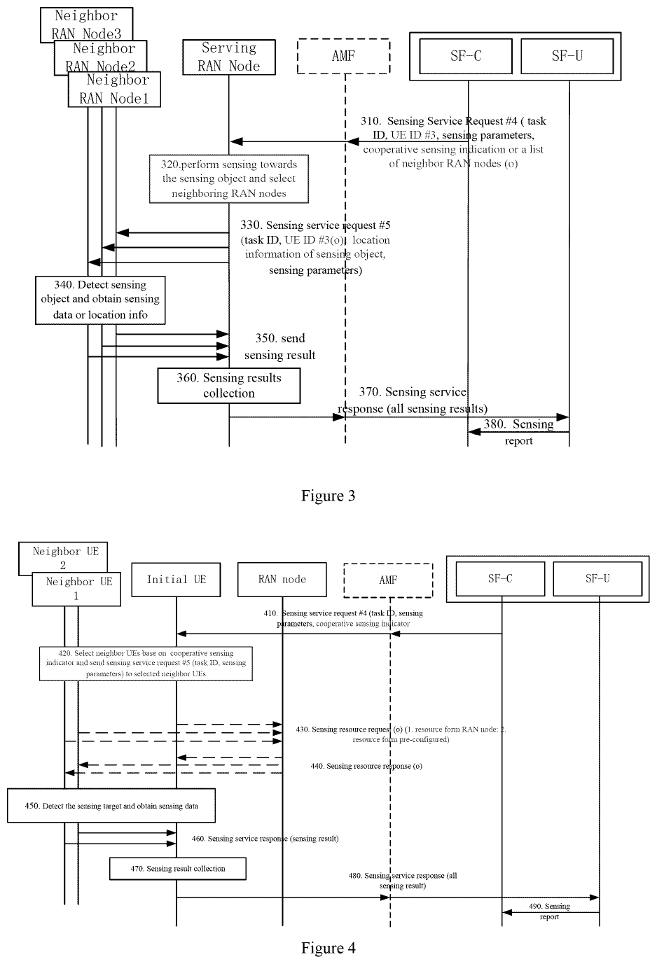

FIG. 3 illustrates a second sub-embodiment of the first embodiment, which relates to serving RAN node triggering the gNB based cooperative sensing. Steps 310-380 are an implementation of step 160.

In step 310, SF-C sends a sensing service request #4 via AMF to the serving RAN node based on the RAN node ID provided by AMF. The sensing service request #4 includes task ID, UE ID (e.g., UE ID #3), sensing parameters and optionally a cooperative sensing indication or a candidate list of neighbor RAN nodes. The candidate list of neighbor RAN nodes of the serving RAN node can be obtained by the SF with any existing method. If the cooperative sensing indication is included, the number of neighbor RAN nodes may be further included. The cooperative sensing indication or the candidate list of neighbor RAN nodes indicates to the serving RAN node that cooperative sensing is to be performed. Incidentally, for loosely coupled architecture, SF (e.g., SF-C) can send the sensing service request #4 directly to the RAN node without going through AMF. The cooperative sensing information (i.e., cooperative sensing indication or a candidate list of neighbor RAN nodes) provided by SF-C solves the key issue 2), i.e., how to trigger cooperative sensing.

In step 320, the serving RAN node performs sensing towards the sensing object identified by the UE ID #3, and obtains sensing data (e.g., angle, distance, velocity, etc.) and calculates the location information of the sensing object according to the sensing data.

If neither cooperative sensing indication nor a list of neighbor RAN nodes is included in the sensing service request #4, the serving RAN node determines whether cooperative sensing is necessary. For example, the serving RAN node determines whether cooperative sensing is necessary according to the service type included in the sensing service request #4. In particular, if the service type is multi-directional obstacle detection, cooperative sensing is enabled by default. For another example, the serving RAN node determines whether cooperative sensing is necessary according to whether a predefined accuracy being met by the accuracy of the obtained location information of the sensing object. In particular, if sensing requirement requires a predetermined accuracy while the calculated location information of the sensing object indicates an accuracy that does not meet the predetermined accuracy, cooperative sensing is enabled. In this case, cooperative sensing is triggered by the serving RAN node.

When the cooperative sensing is determined, the serving RAN node selects neighbor RAN nodes, which resolves the key issue 2) how to select neighbor RAN nodes.

If the candidate list of neighbor RAN nodes is included in the sensing service request #4, the serving RAN node selects the neighbor RAN nodes according to the list.

If the candidate list of neighbor RAN nodes is not provided, the serving RAN node can select the neighbor RAN nodes based on the location of the sensing object and information about the neighbor RAN nodes.

If the candidate list of neighbor RAN nodes is included in the sensing service request #4, the serving RAN node selects neighbor RAN nodes from the received list, based on the location of the sensing object and information about the neighbor RAN nodes. If only the number of neighbor RAN nodes is included along with the cooperative sensing indication in the sensing service request #4, the serving RAN node selects neighbor RAN nodes based on the number of RAN nodes along with the location of the sensing object and the information about the neighbor RAN nodes.

The information about the neighbor RAN nodes includes RAN node information (e.g., RAN node ID, sensing capability, supported service type, supported sensing accuracy, location information etc.) of each RAN node, and can be obtained by the serving RAN node by one of the following manners:
1) RAN node information of each RAN node is preconfigured in the serving RAN node by OAM.
2) RAN nodes share RAN node information upon Xn interface setup.

In step 330, the serving RAN node sends a sensing service request #5 to each of the selected RAN nodes. The sensing service request #5 includes task ID, UE ID (e.g., UE ID #3) (optional), location information of the sensing object, and sensing parameters. In this case, as the UE does not have a connection with neighbor RAN node, neighbor RAN node is not able to perform sensing based on the UE ID included in sensing service request #5. On the other hand, the neighbor RAN node can identify the sensing object according to the location of the sensing object. It means that the location information of the sensing object solves the key issue 1), i.e., how does each RAN node identify a sensing object (e.g., UE) if the sensing object has not connected to the RAN node.

In step 340, each of the selected neighbor RAN nodes detects the sensing object based on the location information of the sensing object and obtains the sensing data (e.g., angle, distance, velocity, etc.) or location information of the sensing object.

In step 350, each of the selected neighbor RAN nodes sends the sensing result, which is sensing data and/or the location information of the sensing object, together with the task ID and the UE ID #3 (optional) to the serving RAN node.

In step 360, the serving RAN node collects the sensing result with same task ID and UE ID #3 (optional) from the neighbor RAN nodes.

In step 370, the serving RAN node sends a sensing service response (i.e., all sensing results or aggregated sensing results) to SF-U. The all sensing results include: task ID, UE ID #3 (optional), RAN node IDs of the serving RAN node and all selected neighbor RAN nodes and the sensing result associated with each RAN node ID. The serving RAN node may calculate the aggregated sensing result from all the sensing results from itself and neighbor RAN nodes. If a neighbor RAN node provides sensing data, the serving RAN node shall first translate the sensing data into location information based on the sensing data provided by the neighbor RAN node and the location of the neighbor RAN node. That is, the serving RAN node calculates the location information of the sensing object sensed by each neighbor RAN node. For example, the serving RAN node may calculate the current X, Y and/or Z coordinate(s) of the sensing object based on angle, distance information included in the sensing data and the location information of each neighbor RAN node. Besides, the serving RAN node may also be able to predict the X, Y and/or Z coordinate(s) at the next moment based on velocity included in the sensing data. Then the serving RAN node may calculate the average X, Y and/or Z coordinate(s) as the aggregated sensing result based on all the X, Y and/or Z coordinate(s) sensed by itself and the neighbor RAN nodes. Either arithmetic average value or weighted average value may be considered. The serving RAN node then provides SF with the aggregated sensing result.

In step 380, SF-U informs SF-C that it has obtained the sensing data (angle, distance, velocity, etc.) and/or location information.

As a whole, in the second sub-embodiment of the first embodiment, the serving RAN node triggers the gNB based cooperative sensing.

A second embodiment relates to UE based cooperative sensing.

The UE based sensing procedure is substantially the same as the gNB based sensing procedure described with reference to FIG. 1 with the following difference.

In UE based sensing, it is assumed that the sensing target may be a sensing object or a sensing area. The sensing object can be represented by a UE ID as described in the first embodiment. As an example, the sensing area can be used to perceive some physical variable(s) such as temperature, humidity, etc. in an agricultural region, and can be represented by location information of a specific area (referred to as ‘sensing area information’ hereinafter). The sensing area information may be included in the sensing parameters. In this case, sensing result of similar time is meaningful for the consumer to know the whole picture of the temperature and humidity etc. in a particular moment, which is helpful for both timely alarm use and statistical use.

In view of the above, only the UE based cooperative sensing of step 160 is described in detail. For UE based cooperative sensing, the key issues include: 1) how to guarantee the similar sensing time; 2) how to trigger cooperative sensing; and 3) how to select the cooperative sensing UEs (i.e., the UEs that perform the cooperative sensing).

The UE based cooperative sensing can be triggered by SF or by UE.

FIG. 4 illustrates a first sub-embodiment of the second embodiment, which relates to SF triggering UE based cooperative sensing. Steps 410 to 490 are an implementation of step 160.

It is assumed that SF decides that cooperative sensing shall be performed by multiple UEs. It is further assumed that not all of the multiple UEs can be reached by (e.g., connected to) the core network. In view of the above, SF-C can choose one UE as an initial UE to send a cooperative sensing service request.

In step 410, SF-C sends a sensing service request #4 to an initial UE that will perform UE based cooperative sensing. The sensing service request #4 includes task ID, sensing parameters (e.g., including at least one of sensing type, sensing object info or sensing area info, sensing frequency info, sensing waveform info and sensing requirements), and a cooperative sensing indicator. Optionally, in addition to the cooperative sensing indicator, the number of cooperative UEs, or sensing radius is also included in the sensing service request #4. SF may send the sensing service request #4 directly to RAN node with UE ID #4. The UE ID #4 can be 5G-S-TMSI or other UE IDs recognized by the RAN node. Alternatively, SF may send the sensing service request #4 with UE ID #2 to RAN node via AMF. UE ID #2 may be SUPI or 5G-S-TMSI that can be recognized by AMF. AMF may translate UE ID #2 into UE ID #3 recognizable by RAN node, e.g., RAN UE NGAP ID and/or AMF UE NGAP ID. RAN node sends the sensing service request to UE based on UE ID #4 or UE ID #3. Besides, the sensing time info may also be included in sensing service request #4. The sensing time info may include the sensing start time, sensing end time, or only include the sensing deadline time. It means that the sensing shall start from the sensing start time and end at the sensing end time, or the sensing shall start immediately and end at the sensing deadline time.

In step 420, upon receiving the sensing service request #4 including the cooperative sensing indicator, the initial UE selects the neighbor UEs that perform cooperative sensing, and sends a sensing service request #5 to each of the selected neighbor UEs. The sensing service request #5 includes task ID and sensing parameters (e.g., including at least one of sensing time info, sensing type, sensing object info or sensing area info, sensing frequency info, sensing waveform info and sensing requirements). The sensing time info can be included in sensing service request #4 or can be generated by the initial UE.

The selection of neighbor UEs is made by the initial UE. For example, all of neighbors UEs of the initial UE can be selected as the neighbor UEs that perform cooperative sensing, assuming that all the UEs support sensing. Alternatively, some neighbor UEs are selected based on neighbor UEs' sensing capability and/or signal strengths received by the initial UE. Further, if the number of cooperative UEs is also included in the sensing service request #4, the number of selected UEs shall be no larger than the number of cooperative UEs included in the sensing service request #4. If the sensing radius is included in the sensing service request #4, the initial UE may estimate the distance between itself and each neighbor UE based on the signal strength or other ranging method. If the distance for a neighbor UE is smaller than the sensing radius, the neighbor UE can be selected for cooperative sensing. The communication between the initial UE and the neighbor UE is based on the sidelink communication specified by 3GPP, which supports UE-to-UE direct communication using the sidelink resource allocation modes, physical-layer signals/channels, and physical layer procedures. The initial UE may send the sensing service request #5 to each of the selected neighbor UEs by broadcasting a D2D discovery request over sidelink.

Additionally, upon receiving the sensing service request #5, each selected neighbor UE may reply to the initial UE to accept or reject the cooperative sensing. Accordingly, only the neighbor UEs replying with acceptance become the selected neighbor UEs that will perform the cooperative sensing.

Alternatively to sending the sensing service request #5 to each of the selected neighbor UEs, the initial UE may only broadcast a sensing capability query indication to all neighbor UEs. The initial UE sends the sensing service request #5 to each neighbor UE that responds to the sensing capability query indication with the sensing capability.

Based on the above steps, the key issue 2), i.e., how to trigger cooperative sensing and the key issue 3), i.e., how to select the cooperative sensing UEs, are resolved.

In an optional step 430, the sensing resources for performing cooperative sensing are obtained.

In a first implementation, the initial UE sends a sensing resource request towards RAN node to request sensing resources for all the selected neighbor UEs (including the initial UE itself). For example, the sensing resource request includes task ID, the number of sensing resources or all UE IDs which can be recognized by RAN node (e.g., PC5 UE ID, or C-RNTI and gNB ID (optional) or Cell ID (optional) provided by neighbor UE). The sensing time info and a cooperative sensing indicator are optionally included in the sensing resource request. In this way, the RAN node knows that the UEs with UE IDs included in the sensing resource request will perform a same cooperative sensing. The RAN node may allocate sensing resources for all the selected neighbor UEs based on the number of sensing resources or the UE IDs at a similar time or based on the sensing time info. The first implementation only applies to the case that all the neighbor UEs (including the initial UE) connect to the same RAN node. It is assumed that the initial UE knows the RAN node ID of the RAN node (or cell ID of the cell) to which each neighbor UE connects to. Therefore, the initial UE is able to determine whether all the neighbor UEs connect to the same RAN node.

In a second implementation, each selected neighbor UE (including the initial UE) sends a separate sensing resource request towards its serving RAN node to request sensing resource. Furthermore, each separate sensing resource request includes the task ID and optionally a cooperative sensing indictor and sensing time info. In this way, the serving RAN node knows that all the UEs sending a separate sensing resource request including the same task ID and optionally a cooperative sensing indicator will perform a same cooperative sensing. The serving RAN node may allocate sensing resources (e. g, time and frequency resource information) for all the selected neighbor UEs (including the initial UE) at a similar time. However, all the UEs may not connect to the same serving RAN node. It means that each UE sends the sensing resource request towards its serving RAN node. In this case, the separate sensing resource request shall include task ID, the sensing time info and optionally a cooperative sensing indicator. That is, all the UEs provide the same sensing time info. All RAN nodes that receive the sensing resource request allocate sensing resources for the requested UEs based on the sensing time info. In this way, it is possible that all the selected neighbor UEs (including the initial UE) perform sensing at a similar time.

In a third implementation, each selected neighbor UE may select sensing resource from a resource pool of pre-configured sensing resources (that that was previously allocated by gNB, as specified by 3GPP), respectively, based on the sensing time info included in sensing service request #5 or generated by the initial UE.

In an optional step 440, RAN node (or each of the RAN nodes) sends a sensing resource response to the initial UE and/or each selected neighbor UE. The sensing resource response includes the sensing resource info, which includes the time and frequency resource information.

Based on the above steps, the key issue 1) how to guarantee the similar sensing time is resolved.

In step 450, all selected neighbor UEs and the initial UE perform the sensing task according to the sensing service request #5 and the sensing resource, and obtain separate sensing result, e.g., location information (e.g., X, Y and/or Z coordinate(s)) corresponding to sensing object, or temperature, humidity, etc. corresponding to sensing area.

In step 460, each selected neighbor UEs sends its sensing result to the initial UE. For sensing object, the sensing result may be location information of the sensing object, i.e., X, Y and/or Z coordinate(s). For sensing area, the sensing result may be temperature, humidity etc. and optionally the sensing time and the location information of itself (i.e., the location information of the neighbor UE).

In step 470, the initial UE collects all the sensing results, which are called raw data. It may further aggregate the sensing results, which are called processed data. For example, for location information of the sensing object, the initial UE may calculate the average X, Y and/or Z coordinate(s) based on all the location information provided by all neighbor UEs. Either arithmetic average value or weighted average value may be considered. For temperature and humidity, the initial UE may not further process the raw data provided by the neighbor UE.

In step 480, the initial UE provides SF-U with all the sensing results (i.e., raw data) or an aggregated sensing result (i.e., processed data) via AMF.

In step 490, SF-U collects the sensing results and informs SF-C that it has obtained the sensing results. For the sensing area case, SF-U or SF-C may further acquire each UE's location information based on current positioning mechanism if the location information is not provided by UE.

As a whole, in the first sub-embodiment of the second embodiment, the SF triggers UE based cooperative sensing.

FIG. 5 illustrates a second sub-embodiment of the second embodiment, which relates to UE triggering UE based cooperative sensing. Steps 510-59 are an implementation of step 160.

In step 510, SF provides RAN node with the sensing service request (e.g., sensing service request #4). The sensing service request #4 includes task ID and the sensing parameters. Besides, the sensing time info may also be included in sensing service request #4.

In step 520, the RAN node checks the sensing service request #4, and decides to ask initial UE to perform sensing. For example, the sensing type included in the sensing service request #4 is a sensing type that is more suitable to be performed by UE, e.g., the sensing type is the obstacle detection around the UE, or temperature, humidity detection for agriculture usage. The RAN node forwards the sensing service request #4 toward initial UE.

In step 530, the initial UE decides to perform cooperative sensing. For example, the initial UE may decide to perform cooperative sensing based on a cooperative sensing indication included in the sensing service request #4, or based on its own decision. In this way, the key issues 2), i.e., how to trigger cooperative sensing, is resolved.

The initial UE selects the neighbor UEs that perform cooperative sensing, and sends a sensing service request #5 to each of the selected neighbor UEs, with the same procedure as step 420. Similar as step 420 and 430, sensing time info may be included in the sensing service request #5, which targets to resolve the key issue 1) (i.e., how to guarantee the similar sensing time) when all the selected UEs do not connect to the same RAN node. The sensing time info can be included in sensing service request #4 or can be generated by the initial UE.

Optionally, the sensing service request #5 includes an indication of reporting to RAN node. If the indication of reporting to RAN node is true (e.g., ‘1’), each selected neighbor UE provides the sensing result (along with the task ID) to the RAN node. If the RAN node receives sensing result for an unknown task ID, it will distribute the task ID and the sensing result to the neighbor RAN node(s). Only the RAN node which is assigned with the task ID by SF will further process the sensing result. If the indication is false (e.g., ‘0’) or the indication of reporting to RAN node is not included in the sensing service request #5, each selected neighbor UE provides task ID and sensing result to the initial UE.

Optional step 540 is the same as step 430, in which the sensing resources for performing cooperative sensing are obtained.

Optional step 550 is the same as step 440.

Step 560 is the same as step 450.

If the indication of reporting to RAN node included in the sensing service request #5 is false (it means reporting to initial UE), each selected UE sends the sensing result to the initial UE in step 570A. If the indication of reporting to RAN node included in the sensing service request #5 is true, each selected UE sends the sensing result and optionally the location information of itself to the RAN node in step 570B. In addition, when the initial UE provides RAN node with sensing result, an indication of cooperative sensing and/or the number of cooperative UEs are also provided. Then the RAN node may wait until all the neighbor UEs provide their own sensing result before performing step 580B. However, all the UEs may not connect to the same RAN node. In this case, the RAN node in the figure refers to each RAN node each UE connects to, which may be different from one to another. If a RAN node receives a sensing result from UE with an unknown task ID, then it will forward the sensing result together with task ID to neighbor RAN node(s) via X2 or Xn interface. If the RAN node of the initial UE receives sensing result with a known task ID, i.e., the same as the one included in the sensing service request #4 in step 510, the RAN node of the initial UE shall collect the sensing result with the same task ID. Alternatively, the RAN node forwards the sensing result with task ID to SF anyway, without checking the task ID is known or unknown.

Following step 570A, in step 580A, the initial UE collects all the sensing results and handles all the sensing results as stated in step 470. In particular, the RAN node needs to receive the sensing results provided by all the selected neighbor UEs (including the initial UE) to aggregate all the sensing results if processed data is needed. The initial UE provides SF with all the sensing results (i.e., raw data) or an aggregated sensing result (i.e., processed data) via AMF. Alternatively, the initial UE provides RAN node all the sensing results or the aggregated sensing result. RAN node further provides all the sensing results or the aggregated sensing result to SF via AMF.

Following step 570B, in step 580B, RAN node provides SF with all the sensing results or an aggregated sensing result. If an indication of cooperative sensing is provided by the initial UE, the RAN node will wait for a moment for the neighbor UE to provide sensing result. In this case, a timer may be set for the RAN node to collect all the sensing results. If an indication of cooperative sensing and the number of cooperative UEs are provided by the initial UE, the RAN node will wait for all the neighbor UEs to provide their own sensing result. After that, RAN node may perform aggregation of the sensing result as stated in step 470.

In step 590, SF-U collects the sensing result and informs SF-C that it has obtained the sensing result.

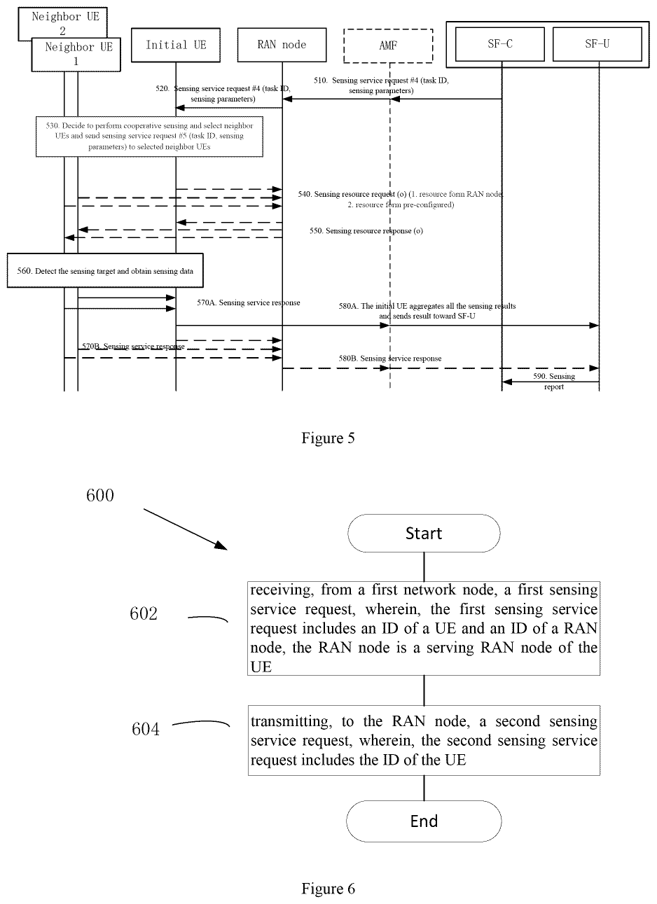

FIG. 6 is a schematic flow chart diagram illustrating an embodiment of a method 600 according to the present application. In some embodiments, the method 600 is performed by a network function such as an SF. In certain embodiments, the method 600 may be performed by a processor executing program code, for example, a microcontroller, a microprocessor, a CPU, a GPU, an auxiliary processing unit, a FPGA, or the like.

The method 600 may comprise: 602 receiving, from a first network node (e.g., AMF or AF), a first sensing service request, wherein, the first sensing service request includes an ID of a UE (which indicates a sensing object) and an ID of a RAN node, the RAN node is a serving RAN node of the UE; and 604 transmitting, to the RAN node, a second sensing service request, wherein, the second sensing service request includes the ID of the UE.

In some embodiment, the second sensing service request further includes cooperative sensing information. The cooperative sensing information may be a cooperative sensing indication or a list of neighbor RAN nodes of the RAN node.

In some embodiment, the method further comprises receiving, from the RAN node, a primary sensing result including the location of the UE; determining whether to perform a cooperative sensing involving neighbor network nodes of the RAN node; transmitting, to each of the determined neighbor network nodes, a third sensing service request including the location information of the UE; and receiving, from each of the determined neighbor network nodes, a sensing result. In some embodiment, whether to perform the cooperative sensing is determined according to a service type included in the first sensing service request; or whether a predefined accuracy being met by the accuracy of the location information of the UE based on the primary sensing result. In some embodiment, the neighbor network nodes of the RAN node are determined according to location information of the UE based on the primary sensing result, and information about neighbor RAN nodes. The information about the neighbor RAN nodes may be pre-configured, obtained from the first network node, or obtained from a second network node.

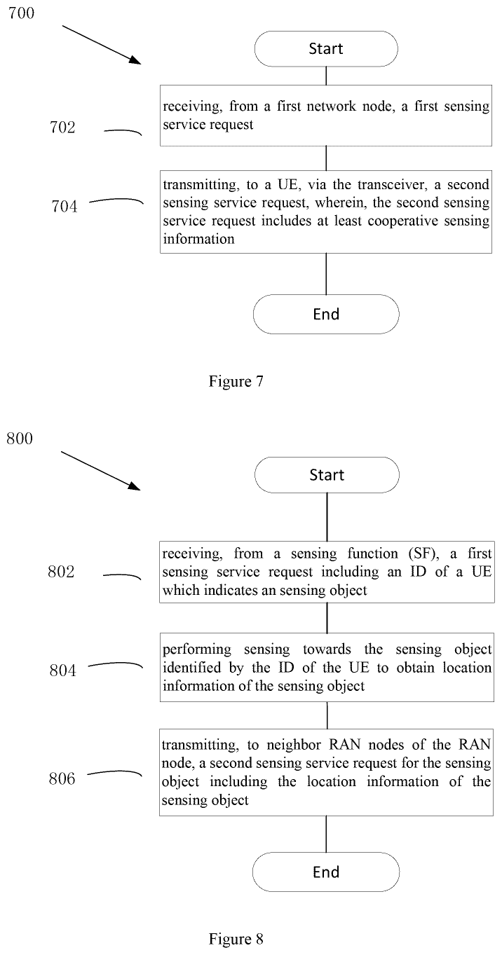

FIG. 7 is a schematic flow chart diagram illustrating an embodiment of a method 700 according to the present application. In some embodiments, the method 700 is performed by a network function such as an SF. In certain embodiments, the method 700 may be performed by a processor executing program code, for example, a microcontroller, a microprocessor, a CPU, a GPU, an auxiliary processing unit, a FPGA, or the like.

The method 700 may comprise: 702 receiving, from a first network node, a first sensing service request; and 704 transmitting, to a UE, via the transceiver, a second sensing service request, wherein, the second sensing service request includes at least cooperative sensing information.

In some embodiment, the method may further comprise receiving, from the UE, a sensing result of the cooperative sensing.

FIG. 8 is a schematic flow chart diagram illustrating an embodiment of a method 800 according to the present application. In some embodiments, the method 800 is performed by a network node such as a RAN node. In certain embodiments, the method 800 may be performed by a processor executing program code, for example, a microcontroller, a microprocessor, a CPU, a GPU, an auxiliary processing unit, a FPGA, or the like.

The method 800 may comprise: 802 receiving, from a sensing function (SF), a first sensing service request including an ID of a UE which indicates an sensing object; 804 performing sensing towards the sensing object identified by the ID of the UE to obtain location information of the sensing object; and 806 transmitting, to neighbor RAN nodes of the RAN node, a second sensing service request for the sensing object including the location information of the sensing object.

In some embodiment, the method further comprises determining to transmit the second sensing service request according to a service type included in the first sensing service request; or whether a predefined accuracy being met by the accuracy of the obtained location information of the sensing object.

In some embodiment, the neighbor RAN nodes are determined according to an indication of cooperative sensing included in the first sensing service request.

In some embodiment, the neighbor RAN nodes are determined according to a list included in the first sensing service request.

In some embodiment, the neighbor RAN nodes are determined according to the obtained location information of the sensing object, and information about neighbor RAN nodes.

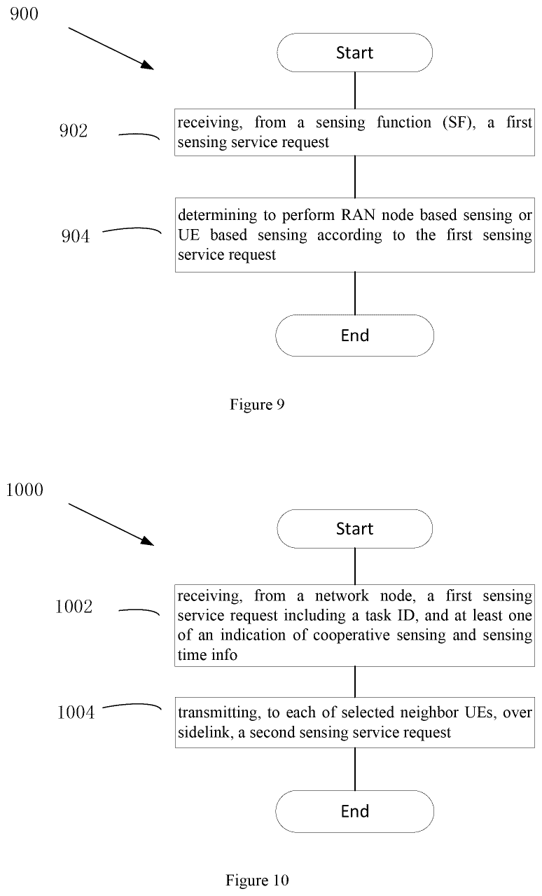

FIG. 9 is a schematic flow chart diagram illustrating an embodiment of a method 900 according to the present application. In some embodiments, the method 900 is performed by a network node such as a RAN node. In certain embodiments, the method 900 may be performed by a processor executing program code, for example, a microcontroller, a microprocessor, a CPU, a GPU, an auxiliary processing unit, a FPGA, or the like.

The method 900 may comprise: 902 receiving, from a sensing function (SF), a first sensing service request; and 904 determining to perform RAN node based sensing or UE based sensing according to the first sensing service request.

In some embodiment, if UE based sensing is determined, the method further comprises transmitting, to an initial UE, the first sensing service request.

In some embodiment, the method further comprises allocating sensing resources for UEs at a similar time upon receiving the same task ID from multiple UEs requesting for sensing resources if UE based sensing is determined.

FIG. 10 is a schematic flow chart diagram illustrating an embodiment of a method 1000 according to the present application. In some embodiments, the method 1000 is performed by an apparatus, such as a remote unit (e.g., UE). In certain embodiments, the method 1000 may be performed by a processor executing program code, for example, a microcontroller, a microprocessor, a CPU, a GPU, an auxiliary processing unit, a FPGA, or the like.

The method 1000 may comprise: 1002 receiving, from a network node, a first sensing service request including a task ID, and at least one of an indication of cooperative sensing and sensing time info; and 1004 transmitting, to each of selected neighbor UEs, over sidelink, a second sensing service request.

In some embodiment, the method further comprises transmitting a first sensing resource request to a serving RAN node of the UE, wherein, the first sensing resource request includes the number of sensing resources, and at least one of an indication of cooperative sensing and sensing time info.

In some embodiment, the method further comprises transmitting a second sensing resource request to a serving RAN node of the UE, wherein, the second sensing resource request includes the task ID, and at least one of an indication of cooperative sensing and sensing time info.

In some embodiment, the method further comprises selecting sensing resource from a resource pool of pre-configured sensing resources based on sensing time info. The sensing time info may be included in the first sensing service request or generated by the UE.

In some embodiment, the second sensing service request includes at least one of sensing time info and an indication of reporting to RAN node.

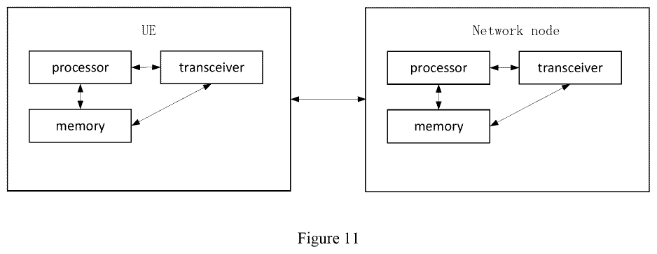

FIG. 11 is a schematic block diagram illustrating apparatuses according to one embodiment.

The network function or network node or network entity (e.g., SF or RAN node) includes a processor, a memory, and a transceiver. The processor implements a function, a process, and/or a method which are proposed in FIG. 6 or 7 or 8 or 9.

A first SF comprises a processor and a transceiver coupled to the processor, wherein the processor is configured to receive, from a first network node, via the transceiver, a first sensing service request, wherein, the first sensing service request includes an ID of a UE and an ID of a RAN node, the RAN node is a serving RAN node of the UE; and transmit, to the RAN node, via the transceiver, a second sensing service request, wherein, the second sensing service request includes the ID of the UE.

In some embodiment, the second sensing service request further includes cooperative sensing information. The cooperative sensing information may be a cooperative sensing indication or a list of neighbor RAN nodes of the RAN node.

In some embodiment, the processor is further configured to receive, from the RAN node, via the transceiver, a primary sensing result including the location of the UE; determine whether to perform a cooperative sensing involving neighbor network nodes of the RAN node; transmit, to each of the determined neighbor network nodes, via the transceiver, a third sensing service request including the location information of the UE; and receive, from each of the determined neighbor network nodes, via the transceiver, a sensing result. In some embodiment, whether to perform the cooperative sensing is determined according to a service type included in the first sensing service request; or whether a predefined accuracy being met by the accuracy of the location information of the UE based on the primary sensing result. In some embodiment, the neighbor network nodes of the RAN node are determined according to location information of the UE based on the primary sensing result, and information about neighbor RAN nodes. The information about the neighbor RAN nodes may be pre-configured, obtained from the first network node, or obtained from a second network node.

A second SF comprises a processor and a transceiver coupled to the processor, wherein the processor is configured to receive, from a first network node, via the transceiver, a first sensing service request; and transmit, to a UE, via the transceiver, a second sensing service request, wherein, the second sensing service request includes at least cooperative sensing information.

In some embodiment, the processor is further configured to receive, from the UE, via the transceiver, a sensing result of the cooperative sensing.

A first RAN node comprises a processor and a transceiver coupled to the processor, wherein the processor is configured to receive, from a sensing function (SF), via the transceiver, a first sensing service request including an ID of a UE which indicates an sensing object; perform sensing towards the sensing object identified by the ID of the UE to obtain location information of the sensing object; and transmit, to neighbor RAN nodes of the RAN node, via the transceiver, a second sensing service request for the sensing object including the location information of the sensing object.

In some embodiment, the processor is further configured to determine to transmit the second sensing service request according to a service type included in the first sensing service request; or whether a predefined accuracy being met by the accuracy of the obtained location information of the sensing object.

In some embodiment, the neighbor RAN nodes are determined according to an indication of cooperative sensing included in the first sensing service request.

In some embodiment, the neighbor RAN nodes are determined according to a list included in the first sensing service request.

In some embodiment, the neighbor RAN nodes are determined according to the obtained location information of the sensing object, and information about neighbor RAN nodes.

A second RAN node comprises a processor and a transceiver coupled to the processor, wherein the processor is configured to receive, from a sensing function (SF), via the transceiver, a first sensing service request; and determine to perform RAN node based sensing or UE based sensing according to the first sensing service request.

In some embodiment, if UE based sensing is determined, the processor is further configured to transmit, to an initial UE, via the transceiver, the first sensing service request.

In some embodiment, the processor is further configured to allocate sensing resources for UEs at a similar time upon receiving the same task ID from multiple UEs requesting for sensing resources if UE based sensing is determined.

The UE (i.e., the remote unit) includes a processor, a memory, and a transceiver. The processor implements a function, a process, and/or a method which are proposed in FIG. 10.

The UE comprises a transceiver; and a processor coupled to the transceiver, wherein the processor is configured to receive, from a network node, via the transceiver, a first sensing service request including a task ID, and at least one of an indication of cooperative sensing and sensing time info; and transmit, to each of selected neighbor UEs, via the transceiver over sidelink, a second sensing service request.

In some embodiment, the processor is further configured to transmit, to a serving RAN node of the UE, via the transceiver, a first sensing resource request, wherein, the first sensing resource request includes the number of sensing resources, and at least one of an indication of cooperative sensing and sensing time info.

In some embodiment, the processor is further configured to transmit, to a serving RAN node of the UE, via the transceiver, a second sensing resource request, wherein, the second sensing resource request includes the task ID, and at least one of an indication of cooperative sensing and sensing time info.

In some embodiment, the processor is further configured to select sensing resource from a resource pool of pre-configured sensing resources based on sensing time info.

In some embodiment, the second sensing service request includes at least one of sensing time info and an indication of reporting to RAN node.

Layers of a radio interface protocol may be implemented by the processors. The memories are connected with the processors to store various pieces of information for driving the processors. The transceivers are connected with the processors to transmit and/or receive message or information. Needless to say, the transceiver may be implemented as a transmitter to transmit the information and a receiver to receive the information.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A sensing function (SF) for wireless communication, comprising:
at least one memory; and
at least one processor coupled with the at least one memory and configured to cause the SF to:
receive, from a first network node, a first sensing service request, wherein the first sensing service request includes an identifier (ID) of a user equipment (UE) and an ID of a radio access network (RAN) node, wherein the RAN node is a serving RAN node of the UE; and
transmit, to the RAN node, a second sensing service request, wherein the second sensing service request includes the ID of the UE.

2. The SF of claim 1, wherein the second sensing service request further includes cooperative sensing information.

3. The SF of claim 2, wherein the cooperative sensing information is a cooperative sensing indication or a list of neighbor RAN nodes of the RAN node.

4. The SF of claim 1, wherein the at least one processor is further configured to cause the SF to:
receive, from the RAN node, a primary sensing result including the location of the UE;
determine whether to perform a cooperative sensing involving neighbor network nodes of the RAN node;
transmit, to each of the determined neighbor network nodes, a third sensing service request including the location information of the UE; and
receive, from each of the determined neighbor network nodes, a sensing result.

5. The SF of claim 4, wherein, whether to perform the cooperative sensing is determined based on:
a service type included in the first sensing service request; or whether a predefined accuracy is met by an accuracy of the location information of the UE based on the primary sensing result.

6. The SF of claim 4, wherein the neighbor network nodes of the RAN node are determined according to location information of the UE based on the primary sensing result, and information about neighbor RAN nodes.

7. The SF of claim 6, wherein the information about the neighbor RAN nodes is pre-configured, obtained from the first network node, or obtained from a second network node.

8. A radio access network (RAN) node for wireless communication, comprising:
at least one memory; and
at least one processor coupled with the at least one memory and configured to cause the RAN node to:
receive, from a sensing function (SF), a first sensing service request including an identifier (ID) of a user equipment UE that indicates an sensing object;
perform sensing towards the sensing object identified by the ID of the UE to obtain location information of the sensing object; and
transmit, to neighbor RAN nodes of the RAN node, a second sensing service request for the sensing object including the location information of the sensing object.

9. The RAN node of claim 8, wherein the at least one processor is further configured to cause the RAN node to determine to transmit the second sensing service request based on:
a service type included in the first sensing service request; or
whether a predefined accuracy is met by an accuracy of the obtained location information of the sensing object.

10. The RAN node of claim 8, wherein the neighbor RAN nodes are determined according to an indication of cooperative sensing included in the first sensing service request.

11. The RAN node of claim 8, wherein the neighbor RAN nodes are determined according to a list included in the first sensing service request.

12. The RAN node of claim 8, wherein the neighbor RAN nodes are determined according to the obtained location information of the sensing object, and information about neighbor RAN nodes.

13. A user equipment (UE) for wireless communication, comprising:
at least one memory; and
at least one processor coupled with the at least one memory and configured to cause the UE to:
receive, from a network node, a first sensing service request including a task identifier (ID), and at least an indication of cooperative sensing or sensing time information; and
transmit, to each of selected neighbor UEs over a sidelink, a second sensing service request.

14. The UE of claim 13, wherein, the at least one processor is further configured to cause the UE to transmit, to a serving radio access network (RAN) node of the UE, a first sensing resource request, wherein the first sensing resource request includes a number of sensing resources, and at least the indication of cooperative sensing or the sensing time information.

15. The UE of claim 13, wherein the at least one processor is further configured to cause the UE to transmit, to a serving radio access network (RAN) node of the UE, a second sensing resource request, wherein the second sensing resource request includes the task ID and at least the indication of cooperative sensing or the sensing time information.

16. A method performed by a sensing function (SF), the method comprising:
receiving, from a first network node, a first sensing service request, wherein the first sensing service request includes an identifier (ID) of a user equipment (UE) and an ID of a radio access network (RAN) node, wherein the RAN node is a serving RAN node of the UE; and
transmitting, to the RAN node, a second sensing service request, wherein the second sensing service request includes the ID of the UE.

17. The method of claim 16, wherein the second sensing service request further includes cooperative sensing information.

18. The method of claim 17, wherein the cooperative sensing information is a cooperative sensing indication or a list of neighbor RAN nodes of the RAN node.

19. The method of claim 16, further comprising:
receiving, from the RAN node, a primary sensing result including the location of the UE;
determining whether to perform a cooperative sensing involving neighbor network nodes of the RAN node;
transmitting, to each of the determined neighbor network nodes, a third sensing service request including the location information of the UE; and
receiving, from each of the determined neighbor network nodes, a sensing result.

20. The method of claim 19, wherein, whether to perform the cooperative sensing is determined based on:
a service type included in the first sensing service request; or
whether a predefined accuracy is met by an accuracy of the location information of the UE based on the primary sensing result.
